(19) United States
(12) Patent Application Publication
(10) Pub. No.: US 2008/0057176 A1
(43) Pub. Date: Mar. 6, 2008

(54) Process For The Preparation Of A Water Continuous Acidified Emulsion And Product Obtainable By The Process

(76) Inventors: Arjen Bot, Vlaardingen (NL); Sotirios Kiokias, Vlaardingen (NL); Christel Karine Reiffers-Magnani, Vlaardingen (NL); Aleksander Reszka, Vlaardingen (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/574,884

(22) PCT Filed: Aug. 26, 2004
(86) PCT No.: PCT/EP04/09560

§ 371 Date: Apr. 9, 2007

(30) Foreign Application Priority Data
Oct. 10, 2003 (EP) 03078162.9

(51) Int. Cl. A23D 7/04; A23D 7/005

(52) U.S. Cl. 426/602

(57) ABSTRACT

The invention relates to a process for preparing water continuous acidified emulsions that can be used as a spread on food prnducts including bread or toast or as a semi-solid acidified crean. The process comprises the step of homogenising an emulsion comprising 15 to 50% fat and protein at a low temperature followed by heating followed by a siep of acidification. The product so produced is stable to repeated cyclic temperature changes that the product undergoes between when it is stored in the refrigerator at about 5° C. and when it is taken out for use when it warms up to ambient temperatures of about 25° C. The invention also relates to a stable water continuous acidified emulsion.

### FIELD OF THE INVENTION

The invention relates to a process for preparing a water continuous spreadable acidified food product comprising fat and protein that is stable to cyclic temperature changes. The invention also relates to a food product that is a water continuous emulsion that comprises fat and protein that is stable when the product is subjected to cyclic temperatures changes between that of storage at refrigeration temperatures and exposure to ambient temperatures when being used.

### BACKGROUND ART

Water continuous emulsions as food products have been prepared starting with fat and have been used as spreads on a variety of food products like on bread and toast.

Spreads should have a good mouthfeel; meaning that they should have a not too high melting point and a steep melting line such that the spread melts quickly in the mouth upon consumption and no waxy mouthfeel is apparent.

In addition, the consumer prefers that the spreadable product maintains its firm shape when stored at refrigeration conditions as well as when taken out for use at ambient temperatures. The product should also have a soft consistency such that when it is applied on a soft surface like a bread, it should spread easily and not tear the bread. The source of the fat for preparing such products are o duar-y, vegetable, or marine origin. The protein contributes to the texture of such products and proteins have been used from dairy source like m4ilk arnd from vegetable source like soy and pea. Processes to prepare such products have been described in the prior art.

WO97/08956 (Unilever, 1997) describes a vegetable and dairy fat based spread that comprises fat of which 10-55% is a non-dairy fat, up to 4.5% milk protein, gelatine or gelatine replacer and optionally up to 1% structuring agent and having a pH in the range of 4.6 to 5.2 and a Stevens firmness value of 200-500 g at 20° C. and a value of 50-250 g at 20° C. The process for preparing this comprises the steps of pasteurising the desired mixture by heating to high temperature, cooling to a culturing temperature, adding acidifying bacteria to acidify the mixture to the desired pH, heating the mixture to above 60° C. to inactivate the culturing organisms, followed by homogenising the mixture at 50-600 bar, preferably at a temperature higher than 60° C. followed by filling in container and cooling to desired temperatures.

WO03/043430 (Unilever, 2003) describes a food product having a dispersed oil phase and a continuous aqueous phase, the product comprising 5 to 40% fat of either dairy, vegetable or marine source, from 0.05 to 15% protein and 0.01 to 3% biopolymer the product having a pH in the range of 3.7 to 5.8. The product is prepared by a process comprising the steps of preparing the agueous phase, mixing the agueous phase with fat, heating to a pasteurisation temperature, homogenising the mixture at a temperature above the meltirig point of the fat, acidification to the desired pH and followed by one more step of homogenisation.

International Dairy Journal 12 (2002) 889-897 describes experiments where model oil-in-water emulsion were prepared. Experiments were conducted where the samples were heated before homogenisation and also where samples were heated after homogenisation. However the samples were prepared close to neutral pH (6 to 8).

The consumer often stores the product in the refrigerator (which may be from about 1 to 12° C.) for ensuring extended use and takes the product out for consumption when the product warms up to ambient temperatures (of about 20 to 30° C.). After some of the product is used, the container is placed back in the refrigerator. This temperature cycling may occur many times over the time the contents of the container are used up. Spreads based on butterfat or milkfat, and other crystalline fat, like the ones in EP-A-603981 and EP-A-1201134, DE-3324821, DE-3907676 remain stable under such conditions; their consistency does not change much. In addition, spreads made from liquid oil (not crystalline) such as sunflower oil are also stable when subjected to temperature cycling and do not harden.

Fats that are partly crystalline, have a lipid phase comprising both fat solids (crystals) and fluid oil. Examples of partly crystalline fat are fat blends with fully hardened coconut fat and/or fully hardened palmkernel oil and palm oil and/or palm oil fractions. These fat blends have a good melting point and a steep melting curve. They provide an emulsion with a good mouthfeel. In addition due to their low unsaturated fatty acid content they have less oxidation problems and therefore less off-taste development upon storage. These fats are therefore suitable to be used ion dairy -arearr-alrmatives and spreads. However, it has been found by the inventors that heated acidified emulsions made of partly crystalline fat, especially the fat blends with fully hardened coconut fat, -and/or fully hardened palmkernel oil and palm oil or palm oil fractions, are unstable when subjected to cyclic temperature changes. This was unexpected, as their neutral counterparts based on native protein were stable under temperature cycling. In addition, due to their relative high protein content they were expected to be stable. The emulsions made of partly crystalline fat did not show any hardening upon storage at low temperature but did show an increase in firmness (post-hardening) when subjected to temperature cycling, which is evidenced by an increase in droplet size, measured as d_{3,2} (coalescence). This post-hardening of the product has a negative impact on the spreadability. The post-hardening effect is especially seen in emulsion with a fat content of 15 wt % fat or higher.

The present inventors have now surprisingly found that products that are prepared with a specific ratio of denatured protein to fat and total protein content before homogenisation are much more stable to the cyclic temperature changes that the product undergoes during its extended use. These products are prepared by a process with a specific sequence in process steps.

It is thus an object of the present invention to provide a process to prepare water continuous acidified emulsions that can be used as spreads and are stable to cyclic temperature changes that the product undergoes during use.

It is another object of the present invention to provide an improved process to prepare the emulsions which, in addition to having the desired property of stability under cyclic temperature conditions, can be processed in the manufacturing units of the prior art with minimal modifications and therefore making the processing highly cost effective.

It is yet another object of the present invention to provide for water continuous acidified emulsions comprising fat and protein which may be used as a spread and in addition to having the most important consumer attributes of the prior art food products are also stable to cyclic temperature changes.

### SUMMARY OF THE INVENTION

The first aspect of the invention provides a process for the preparation of a water continuous acidified emulsion comprising 15 to 50 wt % of a partly crystalline fat and 1 to 6 wt % protein, wherein the process comprises the sequence of homogenising at a temperature below 60° C., a water continuous emulsion comprising a partly crystalline fat and protein wherein the percentage of denatured protein on total protein is less than 100−(2.6*a/b), wherein a is the amount of fat on the total product in wt % en b is the amount of total protein on the product in wt %, heating to a temperature above 80° C. for a time longer than 5 minutes, and acidifying to a pH below the pH of gelling of the protein having the highest pH of gelling in the emulsion.

A second aspect of the invention provides for a process for the preparation of a water continuous acidified emulsion comprising 15 to 50 wt % partly crystalline fat and 1 to 6 wt % protein, wherein the process comprises the sequence of homogenising at a temperature below 60° C., a water continuous emulsion comprising fat and protein wherein the percentage of denatured protein is less than 20% on total protein, heating to a temperature and for sufficient time to prepare an emulsion wherein the percentage of denatured protein is more than 20% on total protein and acidifying to a pH below the pH of gelling of the protein having the highest pH of gelling in the emulsion.

Another aspect of the invention provides for a water continuous acidified emulsion prepared by the process according to the first or second aspect of the invention.

### DETAILED DESCRIPTION OF THE INVENTION

The emulsion of the present invention is preferably used as a spread on products like bread toast and crackers or as a semi-solid acidified cream. The emulsion essentially comprises fat and protein dispersed in an aqueous medium.

The fat or fat blend used for this invention is partly crystalline and comprises a vegetable fat. Partly crystalline fat is a fat with a lipid phase comprising both solid fat (crystals) and liquid oil. The solid fat content may be described in terms of Nₜ, wherein N is the amount of solids in wt % on total fat at temperature t. The amount of solid fat may suitably be measured with NMR. For the present invention, partially crystalline fat means that the fat should have a solid fat content of at least 40%, preferably more than 50%, and most preferably more than 65% at storage temperature (preferably 5° C.) and between 0.1 and 10% at elevated temperature (preferably 25° C.), more preferably between 10 and 2% an most preferably between 6 and 2.4%.

Fat is present in the emulsion as prepared by the process of the invention in an amount from 15 to 50 wt % more preferably trom 15 to 35% and more preferably from 15 to 25 wt % or from 15 to 20 wt %.

The fat may be a single fat or a blend of different fats, and it may fractionated.

It was found that homogenised emulsions with a fat content lower than 15 wt % are stable upon temperature cycling. Without wishing to be bound to theory, the inventors believe that the fat droplets of emulsions based on partly crystalline fat partially coalesce upon temperature cycling, which is evidenced by the increase in droplet size, resulting in the firming of the product. In homogenised emulsions with less than 15 wt % fat, the fat droplets appear to be too far apart to coalesce under the conditions of temperature cycling.

The protein used may be any edible protein source but is preferably chosen from one or more of protein like milk protein, soy protein, or pea protein. The milk protein is highly preferred due to its taste and is preferably chosen from milk, skim milk powder, butter milk powder, butter serum powder, whey, whey powder concentrate, whey protein isolate or caseinate. The most preferred proteins are whey, whey protein isolate or whey protein concentrate. Protein is present from 1 to 6 wt %, preferably from 1 to 4 wt %, more preferably from 2 to 4% and most preferably from 2 to 3 wt % in the product as prepared by the process of the invention.

The inventors have also found that the amount of denatured protein in the emulsion before homogenisation is of importance for the stability of the emulsions. Therefore the percentage of denatured protein on total protein should be less than 100−(2.6*a/b), wherein a is the amount of fat on the total product in wt % en b is the amount of total protein on the product in wt %. It was found that the maxituum tolerable percentage of denatured protein depends on the total amount of protein present and on the total amount of fat in the emulsion. Without wishing to be bound to theory, it is believed that the emulsion remains stable during temperature cycling only if before homogenisation sufficient amount of native protein, i.e. non-denatured protein, is present at the oil-water interface of the emulsion to provide a surface coverage of the fat droplets equal to that of emulsions based on native whey proteins. Native proteins are proteins that are not denatured.

Protein denaturation may suitably be measured by reverse phase HPLC techniques.

A preferred method to achieve the desired extent of denaturation is to ensure that the emulsion before the step of homogenisation is not heated to a temperature greater than 60° C.

It is an essential aspect of the present invention that the homogenisation is carried out at a temperature, preferably below the temperature at which there is substantial denaturation of the protein, but above the melting temperature of the fat. A suitable temperature is 60° C. or below. Without wishing to be bound by theory, it is believed that the denaturation of the proteins should be effected by heating of the emulsion. If first the formation of a protein layer around the fat droplet is allowed before the protein layer is strengthened by way of formation of intermolecular disulphide bonds by the denaturation, it is believed to result in a more stable imulsioni under the temperature cycling conditions.

The homogenisation step is preferably carried out in the range of 5 to 400 bar, more preferably in the range of 50 to 400, and most preferably in the range of 100 to 350 bar.

The process for preparing the product comprises the steps of homogenising, heating and acidifying. The sequence of process steps is important in achieving the desired product properties. It was found that preheating the mixture and/or acidifying the mixture before homogenisation did not lead to temperature cycling stable emulsions.

The product after homogenisation is heated. The heating conditions are chosen such that at least a part of the native undenatured protein is denatured by the heating.

The extent of denaturation of a protein is a function of the temperature it is subjected to and the time over which the protein is held at the high temperature (see e.g. Dannerberg and Kessler, Journal of Food Science 53 (1988) 258-263). The temperature/time dependency is different for each type of protein.

Hence a judicious choice of temperature and time of heating is chosen to achieve the desired degree of denaturation of the protein. The homogenised emulsion is heated to a temperature above 80° C. to achieve the desired result. The time of heating is preferably from 2 to 120 minutes, more preferably longer than 5 minutes and most preferably from 5 to 120 minutes. Preferably the homogenised emulsion is heated at a temperature above 85° C. for a time longer than 10 minutes, preferably longer than 15 minutes.

The heated sample is then acidified using any known method of acidification to a pH below the pH of gelling of the protein. The method by which the pH of gelling of the protein is measured is described in the experimental section.

When more than one protein is used in the process of the invention, the acidification is done at a pH below the pH of the protein having the highest pH of gelling.

When a protein like whey protein is used, the pH of gelling is about 5.8 and so in this case, the preferred pH over which the emulsion is acidified is about 5.8 to 3.8. The acidification may be carried out using acidifying bacteria or a chemical acidifying agent. When acidifying bacteria are used, the emulsion is cooled to the culturing temperature. When the desired pH is achieved, the emulsion may be heated to a high temperature preferably above 60° C. to inactivate the culturing bacteria.

Optionally the product may be subjected to a further heating step and/or homogenisation step after the acidification step in any order.

Suitably the emulsion before homogenisation is prepared by mixing fat and protein, in an aqueous phase wherein the percentage of denatured protein on total protein is less than 100−(2.6*a/b), wherein a is the amount of fat on the total product in wt % en b is the amount of total protein on the total product in wt %.

In a preferred embodiment the invention relates to a process for the preparation of a water continuous acidified emulsion comprising 15 to 25 wt % of a partly crystalline fat and 2 to 3 wt % protein, wherein the process comprises the sequence of homogenising at a tempearature below 60° C., a water continuous emulsion comprising a partly crystalline fat and protein wherein the percentage of denatured protein on total protein is less than 67%, heating to a temperature above 85° C. for a time longer than 10 minutes, and acidifying to a pH below the pH of gelling of the protein having the highest pH of gelling in the emulsion.

According to another embodiment, the invention relates to a process for the preparation of a water continuous acidified emulsion comprising 15 to 50 wt % partly crystalline fat and 1 to 6 wt % protein, wherein the process comprises the sequence of homogenising at a temperature below 60° C. a water continuous emulsion comprising fat and protein wherein the percentage of denatured protein is less than 20% on total protein, heating to a temperature and for sufficient time to prepare an emulsion wherein the percentage of denatured protein is more than 20% on total protein and acidifying to a pH below the pH of gelling of the protein having the highest pH of gelling in the emulsion.

Preferably in this embodiment after the heating step the percentage of denatured protein is more than 30% and even more preferably more than 40%.

Preferably the emulsion before homogenisation is prepared by mixing fat and protein, in an aqueous phase where the percentage of denatured protein is less than 20% on total protein.

It is preferred that the process of the invention comprises use of an edible non-dairy fat for example vegetable fat.

The vegetable fat may be selected from any edible source but it is preferred that the fat is chosen from coconut oil, palm kernel oil, palm oil, soyabean oil, rapeseed oil, sunflower oil, safflower oil or hydrogenated products thereof or blends thereof.

The process according to the present invention is in particular suitable for fat or fat blends with a specific fatty acid composition. Triglycerides can be denoted according to their fatty acid composition. Herein U stands for cis-mono- and cis-polyunsaturated fatty acids, H stand for long-chain saturated fatty acids, of 16 carbon atoms (C16) and longer, M is medium-chain saturated fatty acids, i.e. C12 and C14, and Sh is short-chain saturated fatty acids, i.e. C10 and shorter. For example HM2 stands for a triglyceride having one long-chain saturated fatty acids of C16 and longer and two medium-chain saturated fatty acids, (C12-C14).

The present invention is especially suitable for fat blend wherein the combined amount of HM2, M3, MSh2, M2Sh, and HMSh is at least 46 wt % and the amount of U3 is less than 28 wt %, and the combined amount of U3 and H2U is less than 30 wt%, based on total fatty acids.

Fatty acid analysis can suitable be performed with GLC following their conversion to apolar, methyl ester derivatives (FAME) (see e.g. Walter Jennings, Eric Mittlefehldt, Philip Stremple, “Analytical gas chromatography”, Academic Press; 2 edition (Jan. 15, 1197)

Very suitable fat blends according to the convention comprise fully hardened coconut fat, fully hardened palmkernel oil, palm oil and/or palm oil fractions.

The partially crystalline fat preferably comprises at least 50 wt% of fully hardened coconut fat or at least 55 wt % of fully hardened palm kernel oil or combinations of x wt % of fully hardened coconut fat and y wt % of fully hardened palm kernel oil, wherein x+(50/55)y is at least 50, based on weight of fat. More preferably the partially crystalline fat comprises at least 60 wt % of fully hardened coconut fat or fully hardened palm kernel oil and more preferably at least 70 wt % of fully hardened coconut fat or fully hardened palm kernel oil. When combinations of x wt % of fully hardened coconut fat and y wt % of fully hardened palm kernel oil are used preferably x+(50/55)y is at least 60 wt % and more preferably at least 70 wt %. Preferably less than 90% wt of the fat comprises fully hardened coconut fat or fully hardened palm kernel oil or combinations thereof.

It is preferred that the process of the invention is carried out using a chemical acidifying agent. When a chemical acidifying agent is used, the agent may be added at any temperature and preferably the temperature to which the emulsion is heated is not changed before adding the chemical acidifying agent. The chemical acidifying agent is any food grade agent which may effect lowering of the pH to the desired range. Preferred acidifying agents are citric acid, hydrochloric acid and acetic acid.

A preservative may be added at any stage of the process to ensure a longer shelf life of the product. Any food grade preservative may be added, the preferred ones being potassium sorbate, nisin and acetic acid.

In another embodiment of the present invention biopolymers may be added to the emulsion at an amount of 0-0.5 wt %. Preferably the biopolymer is added before hcmogenisation. Guar, high-methoxy pectin and gelatine are suitable biopolymers.

The invention also provides for a water continuous acidified emulsion comprising fat and protein as prepared by the process of the invention. The emulsions of the invention are stable under temperature cycling. Stable under temperature cycling means that the d_{3,2} value of the droplets in the emulsion does not change by more than 25% percent over three temperature cycles, each cycle consisting of four hours at 25° C. and twenty hours at 5° C.

The invention thus provides for a water continuous acidified emulsion comprising fat and protein, having a pH in the range of 5.8 to 3.8. The fat is present in this emulsion in the range of 15 to 50% more preferably from 15 to 25%. Protein is present from 1 to 6 wt % preferably from L to 4 wt %, more preferably from 2 to 4 wt % and most preferably from 2 to 3 wt %. It is particularly preferred that the protein is whey protein.

Preferably the firmness value of the product does not change by more than 25 percent over three temperature cycles, each at of 5° C. The procedure for measuring the firmness value as Stevens is set out below.

### Experimental Section

### Measurement of the Gelling pH of a Protein

The gelling pH may be determined by preparing a protein solution at the same concentration as the water phase of the emulsion. Other relevant parameters, such as salt concentration should be kept identical to the water phase composition of the emulsion as well. The slowly dissociating acid glucono-delta-lactone (GDL) is added in a concentration such that the change in pH is slow at the gelling pH of the protein. The exact amount depends on the protein sample, but a typical value would be 1% GDL in a 3% protein solution. Immediately after addition of the GDL, the solution is loaded in a stress-controlled rheometer (e.g. Carrimed AR1000) and the storage and loss moduli G′ and G″ are measured for a small oscillation amplitude (in the linear viscoelastic regime, strain typically 10⁻³). If tan delta=G″/G′ decreases to unity, the pH of the solution at this point is taken as the gelling pH of the protein solution.

### Stevens Firmness

The firmness of the products is determined by measuring the force required to penetrate a cylindrical probe in the product. The peak force (by custom expressed in gram, g; 1 g=9.81 mN) is recorded, and averaged over triplicate measurements.

Sample height 5 cm; cylindrical probe of 0.5 inch thickness; compression rate 2 mm/s; penetration depth 20 mm. A suitable machine may be a Stable Micro Systems TA-XT2 Texture Analyzer.

d_{3,2} Value Measurements

O/w emulsions were filled to a height of 15 mm in NMR tubes of 10 mm diameter, and thermally equilibrated for 30 min at 20° C. A restricted diffusion-based droplet size was obtained by means of pfg-NMR using a Bruker Minispec MQ20. The details of the technique are discussed by Goudappel et al (Journal of Colloid and Interface Science 239, (2001) 535-542). A measurement yields values for the volume weighted geometric mean diameter d_{3,3} and tne width of the droplet size distribution when plotted as a funstn of the logarithm of the diameter τ. These parameters can be converted to the surface weighted mean diameter d_{3,2} using the relation d_{3,2}=d_{3,3} exp(−τ²/2). Measurements were carried out in triplicate and results are expressed in terms of average d_{3,2}values. Definitions of droplet sizes are given by Alderliesten (Particle and Particle Systems Characterization 7 (1990) 233-241, and ibid 8 (1991) 237-241).

### Method to Determine Solid fat Content

The solid fat content (%) may be measured by a suitable analytical method such as NMR. The method used is low resolution NMR with Bruker Minispec apparatus. Reference is made to the Bruker minispec application notes 4,5 and 6.

The percentage of solid fat is determined in bulk fat by low resolution NMR and is defined as the ratio of the response obtained from the hydrogen nuclei in the solid phase and the response arising from all the hydrogen nuclei in the sample (American Oil Chemist Society, AOCS, 1999. Official method Cd 16b-93). The product of this ratio and one hundred is termed the low resolution NMR solid fat content. No correction is made for variations in the proton density between solid and liquid phase. The NMR solid fat content for a sample measured at t ° C. is given the symbol Nₜ.

Suitable instruments adapted to determine the solid fat content are the Bruker Minispecs p2Oi, pc20, pc120, pc120s, NMS120 and MQ20.

Stabilisation and tempering procedure was as follows:

melt fat at 80° C.

5 minutes at 60° C.

about 1 day at 0° C.

30-35 minutes at each chosen measuring temperature.

### Denaturation of Protein Measurements.

Ferreira, Mendes and Ferreira (Analytical Sciences 17 (2001) 499-501 describe a HPLC/UV method to analyze proteins in dairy-type products, which has been adapted for the present purpose.

The chromatographical analysis was carried out using a gradient pump (Shimadzu; LC-10Ai) and degasser (Shimadzu; DGU-14A). Gradient elution was carried out with a mixture of two solvents: Eluent A: 0.04% trifluoroacetic acid in Milli-Q water; Eluent B: 0.04% trifluoroacetic in acetonitrile/Milli-Q water (95/5); Flow: 1 ml/min. The elution profile is given in the table below. Auto injector (Shimadzu; SIL-10AD) with a 5 μl injection volume. The analysis time is 32 minutes.

| Time | | |
|---|---|---|
| (min) | % Eluent A | % Eluent B |
| 0 | 90 | 10 |
| 8 | 63.1 | 36.9 |
| 18 | 53 | 47 |
| 23 | 48 | 52 |
| 27 | 48 | 52 |
| 28 | 90 | 10 |
| 32 | 90 | 10 |

The analytical column (Hamilton) was filled with a Polymeric Reversed Phase (PRP-1) column containing a polystyrene- divinylbenzene copolymer-based packing (column length 150mm; diameter 4.1 mm; particle size 10 μm; pore size in particle 10 nm). The temperature of the column was controlled using a Column Thermostat (Separations; Mistral) at 50° C. The effluent was monitored using a UV/VIS detector (Shimadzu; SPD 10A): λ₁: 214 nm, λ₂: 280 nm, Rnage: 1.0. Aux_range.: 2.

Each protein was identified by means of retention time (one peak at ˜17 min for α-lactalbumin, two peaks at ˜24 and ˜26 min for β-lactoglobulin) and quantified by comparing the peak area to results for a calibration series with pure native standards for α-lactalbumin and β-lactoglobulin with known concentrations in the range of 1-5 mg/ml.

The invention will now be demonstrated with respect to the following non-limiting examples.

### EXAMPLES

### Comparative Example -A

A premix oil-in-water emulsion was prepared by mixing the following: vegetable fat (1:1 mixture of fully hardened coconut oil and fractionated palm oil, N₅=73%, N₂₀=14%, N₂₅=2.4%) at 30%, 4% native whey protein concentrate (Nutrilac QU7560, ex Arla, powder containing 75% protein) potassium sorbate at 0.1% and demineralised water. The mix was then heated to 50° C. in about 20 minutes, subsequently homogenised in an APV Lab1000 homogeniser at 300 bar, and then packed in 100 ml tubs (6.5 cm diameter), sealed and placed for storage in a refrigerator at 5° C. The product has a pH of 6.8.

### Comparative Example -B

A product as per Comparative Example A was prepared except that the sample was acidified using a 50% citric acid solution in demineralised water to a pH of 4.5 after it was homogenised but before being packed.

### Comparative Example -C

A premix as in comparative example A was first prepared. The premix was heated to a temperature of 85° C. in about 20 minutes. The heated mixture was then homogenised in an APV Lab1000 homogeniser at 300 bar. The sample was then acidified to a pH of 4.5 using a 50% citric acid solution in demineralised water. The product was then packed in 100 ml tubs (6.5 cm diameter), sealed and placed for storage in a refrigerator at 5° C.

### Comparative Example -D

A premix as in comparative example A was first prepared. The premix at a temperature of 50° C. was first homogenised in an APV Lab1000 homogeniser at 300 bar. The sample was then heated to a temperature of 85° C. in about 20 minutes. The product having a pH of 6.8 was then packed in 100 ml tubs (6.5 cm diameter), sealed and placed for storage in a refrigerator at 5° C.

### Comparative Example -E

A product as per Comparative Example C was prepared.except that the partly crystalline fat blend in the composition was replaced by (liquid) sunflower oil.

Comparative Example -F

A product as per Comparative Example C was prepared except that the partly crystalline fat blend in the composition was replaced by crystalline butterfat.

### Example -1

A premix as in comparative example A was first prepared. The premix at a temperature of 50° C. was first homogenised in an APV Lab1000 homogeniser at 300 bar. The sample was then heated to a temperature of 85° C. in about 20 minutes and then acidified to a pH of 4.5 using a 50% citric acid solution in demineralised water. The product was then packed in 100 ml tubs (6.5 cm diameter), sealed and placed for storage in a refrigerator at 5°

All samples were stored in the refrigerator at 5° C. for one week and then subjected to experiments of cycling temperature changes that involved three cycles, each cycle consisting of 20 hours at 5° C. and 4 hours at 25° C. At the beginning and the end of the three cycles, the samples were then measured for the d_{3,2} value and the firmness values, as herein above described. The measured values are summarised in Table-1.

TABLE 1

| | d_{3,2} | d_{3,2} | | |
|---|---|---|---|---|
| | start | end | Firmness | Firmness |
| Sample | μm | μm | start, g | end, g |
| Comp. Exp-A | 0.86 | 0.92 | 0 | 0 |
| Comp. Exp-B | 0.89 | 1.51 | 43 | 120 |
| Comp. Exp-C | 0.95 | 1.85 | 355 | 970 |
| Comp. Exp-D | 1.09 | 1.02 | 0 | 0 |
| Comp. Exp-E | 0.75 | 0.71 | 65 | 72 |
| Comp. Exp-F | 0.77 | 0.90 | 260 | 300 |
| Example-1 | 1.10 | 1.15 | 580 | 526 |

The data in Table-1 indicates that butter fat (comparative example F) and non-crystalline liquid oil (comparative example E) are stable under temperature cycling. Furthermore, it shows that the process as per the invention (example 1) provides for a firm emulsion that retains its desired properties when subjected to cycling temperature changes and this is not achieved with the processes of the prior art.

1. Process for the preparation of a water continuous acidified emulsion comprising 15 to 50 wt% of a partly crystalline fat and 1 to 6 wt % protein, wherein the process comprises the sequence of
a) homogenising at a temperature below 60° C.,
a water continuous emulsion comprising a partly crystalline fat and protein wherein the percentage of denatured protein on total protein is less than 100−(2.6*a/b), wherein a is the amount of fat on the total product in wt % and b is the amount of total protein on the product in wt %,
b) heating to a temperature above 80° C. for a time longer than 5 minutes, and
c) acidifying to a pH below the pH of gelling of the protein having the highest pH of gelling in the emulsion.

2. Process according to claim 1 wherein the emulsion comprises 15 to 25 wt % of a partly crystalline fat and 2 to 3 wt % protein, wherein the process comprises the sequence of
a) homogenising at a temperature below 60° C., a water continuous emulsion comprising a partly crystalline fat and protein wherein the percentage of-denatured protein on total protein is less than 67%,
b) heating to a temperature above 85° C. for a time longer than 10 minutes, and
c) acidifying to a pH below the pH of gelling of the protein having the highest pH of gelling in the emulsion.

3. Process according to claim 1 wherein the emulsion before homogenisation is prepared by mixing fat and protein, in an aqueous phase.

4. Process for the preparation of a water continuous acidified emulsion comprising 15 to 50 wt %. partly crystalline fat and 1 to 6 wt % protein, wherein the process comprises the sequence of
a) homogenising at a temperature below 60° C., a water continuous emulsion comprising fat and protein wherein the percentage of denatured protein is less than 20% on total protein.
b) heating to a temperature and for sufficient time to prepare an emulsion wherein the percentage of denatured protein is more than 20% on total protein and
c) acidifying to a pH below the pH of gelling of the protein having the highest pH of gelling in the emulsion.

5. Process according to claim 4 wherein the emulsion before homogenisation is prepared by mixing fat and protein, in an aqueous phase where the percentage of denatured protein is less than 20% on total protein.

6. Process according to claim 1 wherein the fat is a vegetable fat.

7. Process according to claim 1, wherein the partially crystalline fat has a fatty acid composition wherein the combined amount of HM2, M3, MSh2, M2Sh, and HMSh is at least 46 wt % and the amount of U3 is less than 28 wt %, and the combined amount of U3 and H2U is less than 30 wt %, based on total fatty acids.

8. Process according to claim 7 wherein the partly crystalline fat comprises least 50 wt % of fully hardened coconut fat or at least 55 wt % of fully hardened palm kernel oil or combinations of x wt % of fully hardened coconut fat and y wt % of fully hardened palm kernel oil, wherein x+(50/55)y is at least 50, based on weight of fat.

9. Process according to claim 1 wherein the product of step (b) is acidified in step (c) to a pH in the range of 5.8 to 3.8.

10. A water continuous acidified emulsion obtainable by the process according to claim 1.

11. A process according to any of claims 1 or a product according to claim 10 wherein the protein is a whey protein.
